(19) United States
(12) Patent Application Publication
(10) Pub. No.: US 2021/0118045 A1
(43) Pub. Date: Apr. 22, 2021

(54) Search Engine for Car Dealerships

(71) Applicant: OAV, LLC, Redlands, CA (US)

(72) Inventor: Skye Haulman, Redlands, CA (US)

(73) Assignee: OAV, LLC, Redlands, CA (US)

(21) Appl. No.: 17/074,516

(22) Filed: Oct. 19, 2020

Related U.S. Application Data
(60) Provisional application No. 62/923,366, filed on Oct. 18, 2019.

(51) Int. Cl. G06Q 30/08; G06F 16/9535; G06F 16/215; G06Q 30/06; G06Q 30/02

(52) U.S. Cl. CPC G06Q 30/08; G06F 16/9535; G06F 16/215; G06Q 30/0631; G06Q 30/0641; G06Q 30/0278; G06Q 30/0623

(57) ABSTRACT

The present invention is directed to a system and method for overcoming lost opportunities in the world of car vetting, bidding, and acquisition. The present invention helps automotive industry individuals and businesses take advantage of opportunities to acquire cars that they previously would not have been able to purchase due to limitations in the present technology in the field. This may be accomplished through enabling a system to compile unstandardized information from various locations throughout the world and standardizing such information by factoring in various inconsistencies that exist based on fragmented descriptions and standards across the automotive industry. The present invention configures a system to allow users to sort through, track, and organize information in a way that has never existed enabling them to make real time decisions on acquisition of automobiles that would not otherwise be possible.

### CROSS-REFERENCE TO RELATED APPLICATION

This patent application claims the benefit of U.S. Provisional Patent Application Ser. No. 62/923,366 entitled “Search Engine for Car Dealerships,” filed Oct. 18, 2019, which application is incorporated in its entirety here by this reference.

### TECHNICAL FIELD

This invention relates to a web application that utilizes new API's, Scraping applications, and unique algorithms to bring together unstandardized data and information from various auction platforms in a standardized form to eliminate the need for fragmented searching.

### BACKGROUND

With normal auction sites users may login in with their individual username and password, from there they typically find the search function from within the site and perform the search for the types of vehicles they are looking for. Each auction site may typically provide a different layout for how the user will review and view vehicle information. There is no standardization within the auction sites. Some of the auction sites may not have a wide array of search filters. The auctions are not well suited for serving as an intermediary between buyers and sellers. These auction platforms consistently input the wrong trim, drive-train, transmission, as well as various other options. This level of inconsistency often leaves a user to deduce the correct options, drivetrain, trim, and various other descriptors from either inconsistent pictures or things such as OEM build sheets which are often not available. Once a user finds a vehicle that they like, they may click on such a vehicle and add it to a watch list. Next, a vetting process for determining the quality of the automobile may occur and once the vetting process is done by utilizing a service provider such as CARFAX, AUTO CHECK, KELLY BLUE BOOK or equivalent the user may place a proxy bid on the vehicle. This proxy bid may happen automatically for the user without the user physically being present at an auction and without them being on-line for an auction.

A typical automotive dealer looking to procure inventory may login to an auctions platform wherein it has been registered to conduct business. There are currently approximately a dozen different main on-line auction sites that a user may login to at different times throughout the day and conduct searches for vehicles within such sites for the inventory that they are looking to buy. When such a user finds vehicle that it likes it may add them to what is known as a “watch list.” The dealer then may login to a separate service provider such as CARFAX or AUTOCHECK to perform vehicle history reports for those vehicles. A user may manually write the results in a note field within the watch list if title is clean, or if there is an accident etc., or there may also be a discrepancy that they want to be made aware of before bidding on such an automobile. The final stage of vehicle evaluation may be to determine book value, dealers located in the Western United States, for example, typically use service providers such as KELLY BLUE BOOK whereas dealers located in the Eastern United States may use NADA or BLACK BOOK. Prior art methods and systems are fragmented base on geographic region along with various other factors that will determine what evaluation tool the dealer may be required to use. The dealer may login to a subscribed service and input a VIN # into an online program and then input the miles, and add the equipment and trim based on what the vehicle is equipped with. In some embodiments, after an evaluation is completed, the user may typically write notes in a note field about the book value. The user may manually then place a proxy bid on the vehicle within the proxy field of a website. The users of prior art platforms must conduct all of these fragmented steps over a plurality of different auction platforms located in various areas around the world.

### SUMMARY

The present invention is directed to a system and method for overcoming lost opportunities in the world of car vetting, bidding, and acquisition. The present invention helps automotive industry individuals and businesses take advantage of opportunities to acquire cars that they previously would not have been able to purchase due to limitations in the present technology in the field. This may be accomplished through enabling a system to compile unstandardized information from various locations throughout the world and standardizing such information by factoring in various inconsistencies that exist based on fragmented descriptions and standards across the automotive industry. The present invention configures a system to allow users to sort through, track, and organize information in a way that has never existed enabling them to make real time decisions on acquisition of automobiles that would not otherwise be possible.

### BRIEF DESCRIPTION OF DRAWINGS

FIG. 1 shows a flow diagram of an embodiment of the present invention;

FIG. 2 shows a flow diagram of a relational database of the present invention; and

FIG. 3 shows a matrix table depicting fragmented data sources.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention and claims therein.

In some embodiments, the present invention may be configured with a dashboard module. The dashboard module may be where an end user of the system may find common information such as saved searches, watch lists, proxy bidding capability, and various other settings that may tailor the present invention to the user's needs.

In some embodiments, the present invention may be configured to enable a user to add specific auction sites that they use in their business. A user may, in some embodiments, for example, select an auction house from a drop-down menu that they would like to add, and configure the login information for such an auction house based on the user's credentials from that auction house.

In some embodiments, the system may be configured to display an error under the if there is something wrong with the auction site configuration to let the user of the system know that they may need to make modifications to their credentials. Additionally, the system may be configured so a user may edit their information with an edit tool to modify, for example, a username and password among other information that may need to be modified.

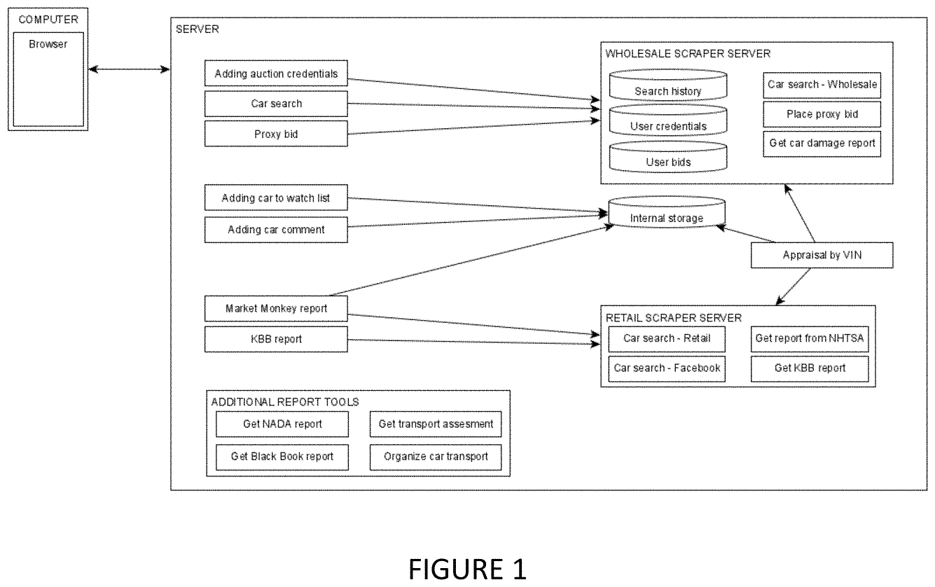

As shown in the flow diagram of FIG. 1, the present invention may, in some embodiments, be configured with a computer and a browser to interact with the server of the present invention. In some embodiments, the present invention may be configured with a backend server wherein the backend server may be configured with a wholesale scraper server, internal storage, retail scraper server, and additional reporting tools. Within the backend server, the present invention may, in some embodiments, be configured with an auction credential adding module that may communicate with a wholesale scraper server module. The backend server may additionally be configured with a car search module that may also be configured to communicate with the wholesale scraper server. Additionally, the backend server may be configured, in some embodiments, with a proxy bidding module. In turn, the proxy bidding module may be configured, in some embodiments to be connected with the wholesale scraper server.

In some embodiments, the present invention may be configured with a car watch list module wherein such a module may be configured with a connection to the internal storage of the backend server. The present invention may also be configured with a car commenting module wherein the car commenting module may be configured with a connection to the internal storage of the backend server.

In some embodiments, the present invention may be configured with a reporting module that may be configured to be connected to the internal storage of the backend server and the retail scraper server of the backend server. Additionally, the present invention may be configured to have, for example a KELLY BLUE BOOK reporting module, a NADA reporting module, BLACKBOOK reporting module, transport assessment module, or an organize car transport module. Each of the above modules, in some embodiments, may be connected to the retail scraper server of the present invention.

In some embodiments, the present invention may be configured with the above-mentioned wholesale scraper server. The wholesale scraper server may, in some embodiments be configured with separate storage modules containing, for example, search history, user credentials, and user bids. The above-mentioned storage modules may be configured to be connected with their respective backend server modules such as, for example, the user bids storage module may be configured to be in connection with the proxy bidding module of the backend server.

Further, the wholesale scraper server may, for example, be configured with a wholesale car search module. Further, the wholesale scraper server may, in some embodiments, be configured with a proxy bid placement module. Further, the wholesale scraper server may, for example, be configured with a damage report retrieval module.

In some embodiments, the retail scraper server may be configured with a retail car search module. Additionally, the retail scraper server may, in some embodiments, be configured with a report retrieval module. The report retrieval module of the retail scraper server may, for example retrieve reports from NHTSA, KBB, or BLACKBOOK. In some embodiments, the retail scraper server may, for example have a car search module that integrates with FACEBOOK car search or other car search platforms such as, for example, EBAY or CRAIGSLIST among various other sales platforms. In some embodiments there may be an external report module that may provide reports from any of the above described external service providers such as KBB, BLACKBOOK, and NHTSA.

In some embodiments, the backend server of the present invention may be configured with an appraisal module. The appraisal module, may, in some embodiments, be configured in connection with the retail scraper server, the internal storage of the backend server, as well as the wholesale scraper server. The appraisal module may, in some embodiments utilize a car's VIN number to retrieve information for analysis and appraisal capabilities. In some embodiments, the present invention may be configured with a machine learning and/or deep learning module that may provide the system the capability to predict the likelihood of resale and profitability for the end user of the present invention in real time. The machine learning and/or deep learning module may also, in some embodiments be trained to predict the type of cars that the end user may be more interested and may filter results based on the users learned preferences.

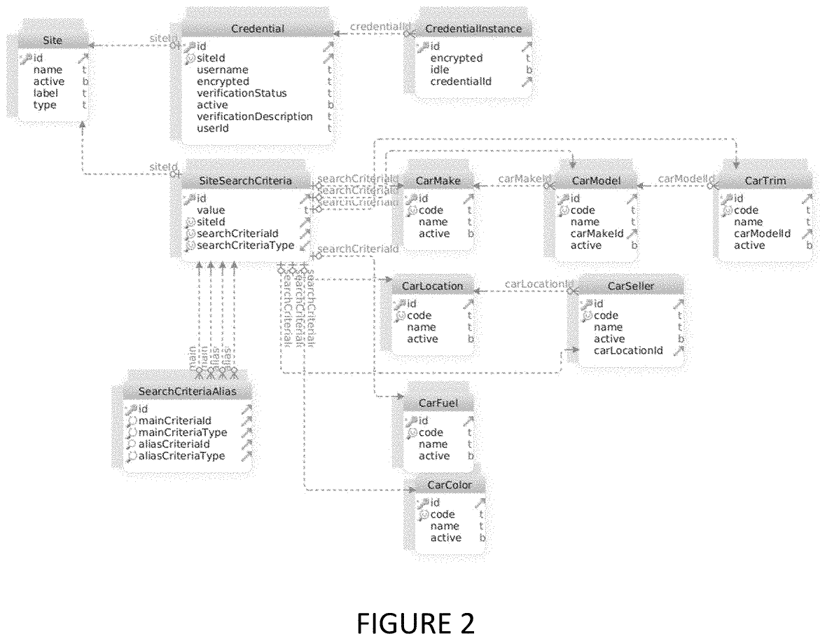

In some embodiments, as shown in the flow diagram of FIG. 2, the present invention may be configured to have a database wherein, in some embodiments the database is a relational database with various car details. In some embodiments, for example, the relational database may be configured to have various categories of information such as, site information, credential information, credential instance information, site search information, car make information, car model information, car trim information, car location information, car seller information, search criteria alias information, car fuel information, car color information, as well as many other types of information pertaining the evaluation of a car or vehicle.

In some embodiments, the site information may be configured to be in connection with the credential information and site search criteria information. The credential information may be configured to be in connection with the site information and the credential instance information. The credential instance information may be configured to be connected with the credential information. In some embodiments, the site search information may be configured to be connected with the site information, the search criteria alias information, the car make information, the car model information, the car trim information, the car location information, the car seller information, the car fuel information, and the car color information.

In some embodiments, the car make information may be configured to be connected with the car model information and the site search criteria information. In some embodiments, the car model information may be configured to be connected with the car make information, the car trim information, and the site search criteria information. In some embodiments, the car trim information may be configured to be connected with the car model information and the site search criteria information. In some embodiments, the car location information may be configured to be connected with the car seller information and the site search criteria information. In some embodiments, the car seller information may be configured to be connected with the car location information and the site search criteria information. In some embodiments, the car fuel information may be configured to be connected with the site search criteria information. In some embodiments, the car color information may be configured to be connected with the site search criteria information.

The present invention may enable a user to login to a plurality of online auction sites within one web application. The present invention may incorporate a proprietary API that may verify user credentials and passwords and then in turn may encrypt and safely store the passwords so only the user and a server making requests may have access to such passwords. The present invention may allow a user to conduct a seamless search within one screen to find vehicles of all kinds that may be dispersed across every existing auction platform and future platforms.

The present invention may, for example, enable a user to search auction platforms that they may be pre-registered with and certify that the user has been approved to conduct business with such an auction platform. The present invention may utilize a proprietary scraping API to search auction platforms based upon a user's input, which may then return results in a standardized output. The present invention may use an algorithm to display the searched results of each auction based upon search processing speed or various other criteria.

In some embodiments of the present invention, for example, the fastest response auctions may display results first, then, slower auction platforms may be displayed in descending order. The present invention may use a proxy server service that may, for example, utilize the geo tags of multiple United States locations. The present invention may be configured so that IP requests that may be made are not by any single IP address. Rather, in some embodiments, for example, the IP addresses may variably change and may be processed by multiple internet service providers so the host servers do not detect a single IP address submitting frequent and consistent requests because this may cause the host servers to identify the single IP address as threat and in turn may block the service. In some embodiments the present invention may have a proprietary matrix table for the makes, models, trim levels, and various other automotive distinctions. In some embodiments, the present invention may create a correlation across different platforms that may be configured to connect parent and child relationships within the data to enable the system to have a user interface that may display standardized data in the same format all the same within a search field.

The present invention may be configured to enable a user to keep a watch list for all auctions on one screen. The present invention may be configured to enable a user to proxy bid vehicles from within a single screen and then view the user's present proxy bids across all auction sites within the same platform. In some embodiments, the present invention may enable a user to update proxy bids across all auction platforms from a single page. This functionality may eliminate the problem of not knowing which proxy bid was used across various web sites across the internet.

In some embodiments of the present invention a user may add website credentials for a host auction site that may include both usernames and passwords in the form of raw text on input from the present system (i.e. in an unencrypted form). The present invention may then utilize a secure website using HTTPS so that the browser may send the information to a server in an encrypted form. Next, in some embodiments, the server may receive such information, decrypt the information using an HTTPS certificate module, and then receive the raw text. Next, in some embodiment, the system may be configured to use AES-256 and SHA-256 HMAC encryption to create a randomly generated key.

Next, in some embodiments, the system may be configured so the raw text may be encrypted and the raw password text may be removed without any trace in the system. In some embodiments, the present system may be configured so the only way to get back a raw password's text may be through decryption using the present invention's API. The API may be configured to have an Access Control List (“ACL”) that may only be accessed by a user that is the credential owner. In some embodiments, even a super admin may not have access in an ACL to read it, this may enable the system to not provide access to anyone except the owner of the credentials. In some embodiments, the system may be configured so that after a user adds credentials in the system, their credentials may not be allowed to immediately be used.

For example, the system may, in some embodiments, use credential verification in the background this may be accomplished by the system checking to see if the credentials may be valid. In the present invention a user may be ready to use the system, however, if their credentials are invalid, the system may be configured to lock the credentials and prevent the user's ability to keep trying to call the server for requests. This may be done to assure that faulty credentials will not be used. The system may be configured, for example, to ban a user due to a plurality or retries when attempting to enter the site without valid credentials.

The present invention may be configured to accomplish an extremely difficult task of collecting data from a plurality of various automotive auction websites and vehicle auction platforms. The present invention may accomplish this tedious task by registering a scraping job specific for each website. The system may be configured to overcome the obstacle of data having to be accessed and scraped differently though different programs. In the present invention, the system may be configured take raw data and sort it within a database.

In some embodiments, the present invention may clean fragmented data that was retrieved from the multiple sources discussed above. Part of the issue with brining down data from numerous sources is that localities throughout the world may use differing standards, labels, identifiers, or inconsistent terminology for the same things. The present invention, in some embodiments, may be able to identify inconsistent data, cleanse and standardize such information, and organize the information in a uniform and standardized manner.

Data cleansing or data cleaning is the process of detecting and correcting corrupt or inaccurate records from a record set, table, or database and refers to identifying incomplete, incorrect, inaccurate or irrelevant parts of the data and then replacing, modifying, or deleting the dirty or coarse data.

In some embodiments, as is depicted in FIG. 1, the present invention may be configured with a wholesale scraper server. The wholesale scraper server may conduct scraping of vehicle data and information relevant to wholesale auctions and other various wholesale purchasing options.

In some embodiments, as is depicted in FIG. 1, the present invention may be configured with a separate retail scraper server. The wholesale scraper server may be configured to conduct the above referenced scraping of vehicle data and information relevant to retail purchasing options.

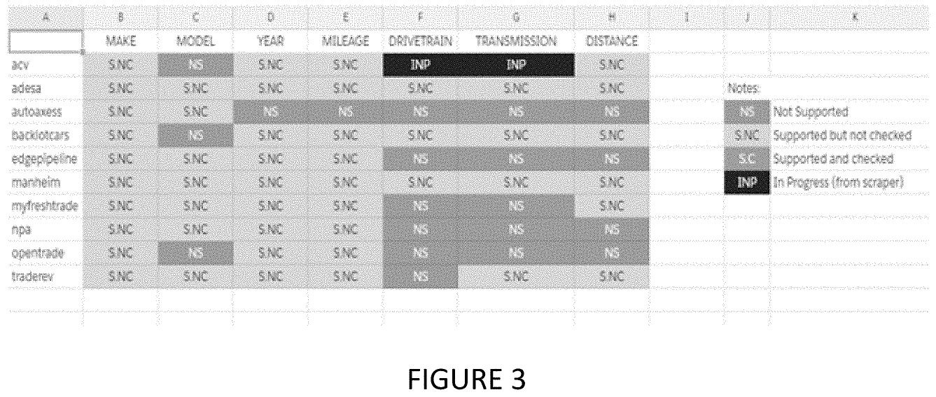

The database may be configured to utilize database software such as MONGO.DB. The present invention may be configured to display the scraped data as a clean output of data in a consistent and easily identifiable output. The present invention may also help with fragmentation of data from some sites that do not support search functions of certain options. For example, as can be seen in FIG. 3, numerous auction platforms do not allow a user to perform searches for simple things such as by model or drive train, type of transmission, or various other automotive identifiers. The present invention may utilize the presently described proprietary scraping API to overcome the issue of unsupported searching across various auction platforms.

The present invention may be configured to utilize a proxy server service with a geo tag of numerous locations so that the Internet Protocol (“IP”) requests that are made are not by any one IP address; rather the IP addresses may change and the requests may be processed by multiple internet service providers so the host servers do not see this functionality as a threat and block the service.

In some embodiments, the present invention may utilize a proxy server that may be configured to provide an IP pool. For the purposes of this application the term IP stands for “internet protocol.” In some embodiments, for example, the IP pool may be configured to help the system switch between internet service providers so the requests for call signs. In other words, the searches and scrapes may not come from the same underlying IP which would ultimately be blocked. In some embodiments, the proxy service in conjunction with the present invention may determine when to switch IPs. The present invention may also be configured to know when to use new proxies and when to keep the old proxies to assure the session is still valid, which, in turn, the search becomes faster because when a session is still valid; there may be no need for the system to be required to re-login. The present invention may also be configured to provide multiple sessions per account, this way, even if a user is only inserting one account and/or credential, they may still utilize the system for multiple searches in a single account. This may be done because a new search may use a new separate session, and will not overwrite or cascade different search result caused due to a session being shared by multiple searches.

The present invention may be configured to utilize a proprietary matrix table to store makes, models, trim levels, and various other automotive details. The present invention may be configured to make a correlation across different platforms that may connect parent and child relationships so all of the information appears in a uniform manner within the same search field.

Further, in some embodiments, the present invention may loop through all possible values for aspects of an automobile such as, for example, the make, model, and trim for each auction platform. The present invention may be configured to compare it with an initially empty table, then, in such an embodiment, if the system has found a new make, model, or matching trim the system may insert such an automobile into the matrix table.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1) A system for car vetting, bidding, and acquisition comprising:
a) a computer with a browser interconnected with a backend server comprising;
i) a wholesale scraper server comprising:
(1) a search history storage medium;
(2) a user credential storage medium;
(3) a user bids storage medium;
(4) a wholesale car search module;
(5) a place proxy bid module; and
(6) a car damage report retrieval module;
ii) a retail scraper server comprising:
(1) a retail car search module;
(2) a Facebook car search module;
(3) a retrieve NHTSA report module; and
(4) a retrieve KBB report module;
iii) an adding auction credential module that is configured to be connected to the wholesale scraper server;
iv) car search module that is configured to be connected to the wholesale scraper server;
v) a proxy bid module that is configured to be connected to the wholesale scraper server;
vi) an appraisal by VIN module that is configured to be connected with the wholesale scraper server, the retail scraper server, and an internal storage module;
vii) an adding car to watch list module that is configured to be connected with the internal storage module;
viii) an adding car comment module that is configured to be connected with the internal storage module;
ix) a market report module that is configured to be connected with the internal storage module and the retail scraper server;
x) an external report module that is configured to be connected with the retail scraper server; and
xi) wherein the system is configured to enable a user of the system to search for, retrieve, and make a purchasing decision on a vehicle by proxy bidding on at least one vehicle without the need to navigate to a plurality of other information sources.

2) The system of claim 1, wherein the system is configured to pull a plurality of data points from a plurality of sources with differing formats of vehicle data.

3) The system of claim 2, wherein the system is configured to cleanse the vehicle data.

4) The system of claim 3, wherein the system is configured to utilize a relational database to store the cleansed data.

5) The system of claim 4, wherein the system is configured to utilize a proxy server service with a geo tag of numerous locations.

6) The system of claim 5, wherein the system is configured to utilize a plurality of IP addresses that change over time to prevent host servers from detecting the present system.

7) The system of claim 6, wherein the system is configured to utilize a proxy server that may be configured to utilize an IP pool.

8) The system of claim 7, wherein the system is configured to utilize a matrix table to store makes, models, trim levels, and a plurality of other automotive details.

9) The system of claim 8, wherein the system is configured to detect new automotive vehicles and insert information relating to such automotive vehicles into the matrix table.

10) A method of operating the system of claim 1, wherein the method comprises:
a) a user adding auction credentials with the auction credential module;
b) the user searching for targeted information with the car search module;
c) the user placing a proxy bid with the proxy bid module; and
d) the user monitoring and updating all of the proxy bids it has made from a single page.

11) A system for car vetting, bidding, and acquisition comprising:
a) a computer with a browser interconnected with a backend server comprising;
i) a wholesale scraper server comprising:
(1) a search history storage medium;
(2) a user credential storage medium;
(3) a user bids storage medium;
(4) a wholesale car search module;
(5) a place proxy bid module; and
(6) a car damage report retrieval module;
ii) a retail scraper server comprising:
(1) a retail car search module;
(2) a Facebook car search module;
(3) a retrieve NHTSA report module;
(4) a retrieve KBB report module; and
iii) wherein the system is configured to enable a user of the system to search for, retrieve, and make a purchasing decision on a vehicle by proxy bidding on at least one vehicle without the need to navigate to a plurality of other information sources.

12) The system of claim 11, wherein the backend server further comprises:
a) an adding auction credential module that is configured to be connected to the wholesale scraper server;
b) a car search module that is configured to be connected to the wholesale scraper server;
c) a proxy bid module that is configured to be connected to the wholesale scraper server; and
d) an appraisal by VIN module that is configured to be connected with the wholesale scraper server, the retail scraper server, and an internal storage module;
e) an adding car to watch list module that is configured to be connected with the internal storage module;
f) an adding car comment module that is configured to be connected with the internal storage module;
g) a market report module that is configured to be connected with the internal storage module and the retail scraper server;
h) an external report module that is configured to be connected with the retail scraper server; and
i) wherein the system is configured to pull a plurality of data points from a plurality of sources with differing formats of vehicle data.

13) The system of claim 12, wherein the system is configured to cleanse the vehicle data.

14) The system of claim 13, wherein the system is configured to utilize a relational database to store the cleansed data.

15) The system of claim 14, wherein the system is configured to utilize a proxy server service with a geo tag of numerous locations.

16) The system of claim 15, wherein the system is configured to utilize a plurality of IP addresses that change over time to prevent host servers from detecting the present system.

17) The system of claim 16, wherein the system is configured to utilize a proxy server that may be configured to utilize an IP pool.

18) The system of claim 17, wherein the system is configured to utilize a matrix table to store makes, models, trim levels, and a plurality of other automotive details.

19) The system of claim 18, wherein the system is configured to detect new automotive vehicles and insert information relating to such automotive vehicles into the matrix table.

20) A method of operating the system of claim 11, wherein the method comprises:
a) a user adding auction credentials with the auction credential module;
b) the user searching for targeted information with the car search module; and
c) the user placing a proxy bid with the proxy bid module.
